(19) United States
(12) Patent Application Publication
(10) Pub. No.: US 2015/0204199 A1
(43) Pub. Date: Jul. 23, 2015

(54) CIRCULATION DEVICE FOR CIRCULATING AN AMBIENT ATMOSPHERE AND METHOD FOR PRODUCING A CIRCULATION DEVICE OF THIS TYPE

(71) Applicant: SCHUNK KOHLENSTOFFTECHNIK, Heuchelheim (DE)

(72) Inventors: Jeremias Schönfeld, Huettenberg (DE); Gotthard Nauditt, Huettenberg (DE); Martin Henrich, Wetzlar (DE); Roland Weiß, Huettenberg (DE)

(21) Appl. No.: 14/420,759

(22) PCT Filed: Aug. 13, 2013
(86) PCT No.: PCT/EP2013/066928

§ 371 Date: Feb. 10, 2015

(30) Foreign Application Priority Data
Aug. 13, 2012 (DE) 10 2012 214 405.6

(51) Int. Cl. F01D 5/28; B29C 65/56; B29C 65/48

(52) U.S. Cl. CPC F01D 5/28; B29C 65/4885; B29C 65/489; B29C 65/4815; B29C 65/565; B29K 2105/0097

(57) ABSTRACT

The invention relates to a circulation device (20) for circulating an ambient atmosphere and to a method for producing a circulation device, the circulation device having a shaft (21), a blade carrier (22) connected to the shaft and a plurality of blades (23) arranged on the blade carrier, both the blade carrier and the blades being realized as CFC components and being interconnected in a force-fitting manner by means of a connecting system exclusively having connecting elements consisting of CFC or graphite and the connecting system having a spring element to consisting of a CFC material.

The invention relates to a circulation device for circulating an ambient atmosphere, the circulation device having a plurality of components that comprise at least a shaft for connecting the circulation device to a driving device, a blade carrier connected to the shaft and a plurality of blades arranged on the blade carrier for applying a flow impulse to the atmosphere, wherein the connection between the shaft and the blade carrier and the connection between the blade carrier and the blades are both realized rigidly for co-rotation so as to transmit a driving torque from the shaft to the blades, and both the blade carrier and the blades are realized as CFC components or at least as partially siliconized CFC components, at least one of the two connections being realized in such a manner that two CFC components or at least partially siliconized CFC components to be interconnected are interconnected in a force-fitting manner by means of a connecting system exclusively having connecting elements consisting of CFC, at least partially siliconized CFC or graphite, and the connecting system having a spring element consisting of a CFC material or an at least partially siliconized CFC material.

The subject-matter of the present invention, also independently of its realization on a circulation device, is a connection between two CFC components or at least partially siliconized CFC components to be interconnected by means of a connecting system exclusively having connecting elements made of CFC, at least partially siliconized CFC or graphite that are interconnected in a force-fitting manner, the connecting system having a spring element consisting of a CFC material or an at least partially siliconized CFC material. In principle, the subject-matter of the invention can be realized whenever a permanently force-fitting connection is to be formed between CFC components or at least partially siliconized CFC components.

Alternatively, the present invention relates to a circulation device for circulating an ambient atmosphere, the circulation device having a plurality of components that comprise at least a shaft for connecting the circulation device to a driving device, a blade carrier connected to the shaft and a plurality of blades arranged on the blade carrier for applying a flow impulse to the atmosphere, wherein the connection between the shaft and the blade carrier and the connection between the blade carrier and the blades are both realized rigidly for co-rotation so as to transmit a driving torque from the shaft to the blades, and both the blade carrier and the blades are realized as CFC components or at least partially siliconized CFC components, at least one of the two connections being realized in such a manner that two CFC components or at least partially siliconized CFC components to be interconnected are interconnected by means of a force-fitting or form-fitting connection that is secured by means of a material-bonded connection in a connecting zone formed between the components.

The subject-matter of the present invention, also independently of its realization on a circulation device, is a connection between two CFC components or at least partially siliconized CFC components to be interconnected in which the components are interconnected by means of a force-fitting or form-fitting connection that is secured by means of a material-bonded connection in a connecting zone formed between the components. In principle, the subject-matter of the invention can be realized whenever a permanently force-fitting connection is to be formed between CFC components or at least partially siliconized CFC components.

It is particularly advantageous if the material-bonded connection has a connecting material that contains silicon.

Further, the present invention relates to a method for producing a circulation device in which, in order to produce a connection between two CFC components or at least partially siliconized CFC components to be interconnected, a force-fitting or form-fitting connection is first formed between the components and then a material-bonded connection with a connection material preferably containing silicon is formed in the area of a connecting zone between the components of the force-fitting or form-fitting connection.

Circulation devices of the kind mentioned above are used for circulating or homogenously mixing a furnace atmosphere in industry furnaces, for example. Furnaces of this kind are used for performing thermal processes, for example, in which carbon materials are subjected to pyrolysis or in which carbon components are carbonized or graphitized.

Irrespective of the individual processes taking place in an industry furnace, the circulation devices used therein are exposed to enormous thermal stresses because temperatures of 2000° C. or more are reached at times in the furnace atmosphere. Due to these high thermal stresses, materials are now routinely used for the circulation devices that are characterized by a particularly low coefficient of thermal expansion, making it possible to limit thermally induced tensions in the used materials. Owing to its high-temperature resistance and its low weight, carbon fiber-reinforced carbon (CFC) and siliconized carbon fiber-reinforced carbon (CMC) have proved to be particularly suitable construction materials for circulation devices, wherein siliconization of CFC construction components essentially affects their surfaces. It is problematic, however, that carbon fiber-reinforced carbon exhibits pronounced anisotropy due to its fiber orientation, which has the result that CFC exhibits a significantly lower coefficient of thermal expansion in the fiber direction than vertical to the fiber direction. Consequently, in connections between CFC components that take place via a screw connection, for example, that have connecting elements consisting of CFC, CMC or graphite, such as a threaded bolt made of CFC or CMC, which is clamped to the CFC or CMC components by means of graphite nuts, significant mechanical tensions may occur in the area of the screw connection in case of crosswise orientations of the fibers of the CFC components and of the connecting bolt. Since CFC has an extremely porous form in particular in the area between the fibers, these tensions can lead to settling phenomena in the area of the screw connection, which may cause the screw connection between the CFC components, which originally acted in a force-fitting manner, to become loose in the course of the temperature stress, and component failure may occur.

One possibility of preventing such a component failure is to define maintenance intervals as a function of the occurring temperature stress in order to be able to replace the screw connections in time before components fail. Since performing the maintenance or inspection of the circulation devices and in particular possibly necessary repairs are accompanied by enormous effort, it is the object of the present invention to enhance circulation devices and propose a method for producing circulation devices to the effect that a permanently force-fitting connection becomes possible between the CFC components or at least partially siliconized CFC components, i.e. CFC components usually siliconized in the area of the surface, of the circulation device.

To attain this object, the circulation device according to the invention has the features of claim 1.

In a first version, the circulation device according to the invention is realized in such a fashion that at least two CFC components or at least partially siliconized CFC components to be interconnected are interconnected in a force-fitting manner by means of a connecting system exclusively having connecting elements consisting of CFC, at least partially siliconized CFC or graphite, the connecting system having a spring element consisting of a CFC material or an at least partially siliconized CFC material.

By using the spring element, it is possible for the first time to compensate settling phenomena in a force-fitting connection between two CFC components or at least partially siliconized CFC components by the effect of a spring element without the use of a material different from the material of the components being necessary for this purpose.

Although it is of course basically known to use a spring element to compensate settling phenomena in screw connections, these known spring elements consisting of metal cannot be used in the circulation device according to the invention since the latter is intended especially for the use in a high-temperature environment. The temperatures in question, which quite often reach 2000° C. and more, exceed the creep limit of metals by far, for example, so that the desired compensating spring effect is no longer available in the afore-mentioned temperature range. By using a spring element consisting of a CFC material or an at least partially siliconized CFC material, the use of spring elements compensating settling phenomena in screw connections which must permanently ensure a force-fitting connection between the components interconnected by means of the screw connection even under high-temperature conditions becomes possible for the first time.

In the major number of cases, it is advantageous to realize the connecting system between the CFC components or at least partially siliconized CFC components as a screw-connection device that has a threaded bolt consisting of a CFC material or an at least partially siliconized CFC material or a graphite material and at least a nut consisting of a CFC material or an at least partially siliconized CFC material or a graphite material, wherein the spring element is arranged between the nut and a CFC component or at least partially siliconized CFC component in such a manner that a pressure force is active between the nut and the CFC component or at least partially siliconized CFC component.

Fundamentally, the use of the spring elements consisting of a CFC material or an at least partially siliconized CFC material is of course not limited to the combination with a connecting system realized as a screw-connection device. Instead, spring elements consisting of a CFC material or an at least partially siliconized CFC material can also be used for compensating settling phenomena in other force-fitting connecting systems, such as a clamping or wedging connection, which allow a mechanically pre-tensioned connection for a force-fitting effect in the same manner as a screw connection.

It is particularly advantageous if the threaded bolt is provided with a bolt head and if the threaded bolt penetrates two CFC components or at least partially siliconized CFC components that are to be interconnected in a force-fitting manner and that are arranged between the bolt head of the threaded bolt and the nut so that the spring element can generally be used in the same manner as a conventional steel spring element, whose use is excluded in the circulation device according to the invention for the afore-discussed reasons.

An overall simple structure of the connecting system including a smallest possible number of different components becomes possible if the bolt head is formed by a nut consisting of a CFC material, an at least partially siliconized CFC material or a graphite material.

In a particularly preferred embodiment of the circulation device, the number of components can be reduced even further if the threaded bolt is formed on a first one of the CFC components or at least partially siliconized CFC components interconnected in a force-fitting manner and penetrates the other CFC component or at least partially siliconized CFC component, which is arranged between the first component and the nut.

In another preferred embodiment, the spring element is realized as a beam spring element and is provided with two support legs for support on a CFC component or at least partially siliconized CFC component and an elastic beam connecting the support legs for support on the bolt head or on the nut of the connecting system.

Alternatively, in another embodiment, it is also possible to realize the spring element as an annular spring element having a spring ring that has support legs on two opposing axial surfaces, said support legs being arranged on the axial surfaces in a radially distributed manner so that a support leg formed on one axial surface is located between two support legs formed on the opposite axial surface.

Irrespective of the material selected for the shaft, which can be produced from high-temperature resistant steel in particular in circulation devices that are intended for operation in a furnace that is operated at comparatively low temperatures, it is advantageous if the shaft is realized in such a fashion that it has a plate flange formed on one axial connecting end, including a radially extending flange ring on which a blade carrier is formed, said blade carrier having the shape of a disk, wherein the connecting system is realized as a screw-connection device between the shaft and the blade carrier.

In a particularly advantageous manner, the circulation device is also suited for high-temperature use if the blade carrier, the blades and the shaft are all realized as CFC components or at least partially siliconized CFC components.

If the flange ring of the shaft is connected to the blade carrier by means of a plurality of threaded bolts arranged in a radially distributed manner for connecting the shaft to the blade carrier, the shaft being realized as a CFC component or at least partially siliconized CFC component in correspondence to the blade carrier and the blades, and if the threaded bolts are each provided with a beam spring element, the circulation device in its entirety can be composed of CFC components or at least partially siliconized CFC components with a high-temperature resistant, permanently force-fitting connection between the shaft and the blade carrier.

In particular if a different material, such as steel, is used for the shaft, it is advantageous if the shaft is provided with a connecting piece at one axial end for realizing the screw-connection device, said connecting piece having a threaded bolt, and if the connecting system is realized as a screw-connection device between the shaft and the blade carrier. This kind of structure of the circulation device allows forming the connecting piece from a different material than the shaft, for example, i.e. forming the connecting piece as a CFC piece, an at least partially siliconized CFC piece or as a graphite piece.

If the threaded bolt of the connecting piece penetrates the blade carrier to form a screw-connection device for connecting the shaft and the blade carrier, an annular spring element being arranged between the connecting piece and the blade carrier, it is possible to provide a permanently force-fitting connection between the shaft and the blade carrier with only one centrally arranged annular spring element.

It is particularly advantageous for the effectiveness of the spring elements if at least the elastic beam of the beam spring element or the spring ring of the annular spring element has a fiber orientation with fibers that extend along a stress axis that connects the support legs.

Another solution for the object according to the invention has the features of claim 14.

The circulation device according to the invention of claim 14 provides that two CFC components or at least partially siliconized CFC components to be interconnected are interconnected by means of a material-bonded connection including a connection material preferably containing silicon in a connecting zone formed between the components.

Thus, the alternative solution of achieving for the first time a permanently force-fitting connection between interconnected CFC components or at least partially siliconized CFC components in a circulation device lies in preventing settling phenomena, which would permit an interruption of the force fit between the interconnected components, by preventing a separation of the components by means of a material-bonded connection.

To achieve this material-bonded connection between the CFC components or at least partially siliconized CFC components, it is basically immaterial in which way the production of the material-bonded connection is made possible, i.e. how the relative arrangement of the CFC components or at least partially siliconized CFC components is achieved that is required as a prerequisite for achieving the material-bonded connection. In principle, this can be achieved by fitting the CFC components or at least partially siliconized CFC components together in a force-fitting manner, i.e. in particular under pre-tension, or by simply arranging the CFC components or at least partially siliconized CFC components relative to each other in a manner defined by a form fit.

It is advantageous in any case if the connecting zone between the CFC components or at least partially siliconized CFC components has a silicon carbide content that decreases with growing distance from a boundary layer formed between the components so that it is ensured on the one hand that there is a material-bonded connection securing the fit between the CFC components, but, on the other hand, that the material-bonded connection is realized in a locally highly limited manner so that the original material properties of the components are influenced as little as possible by the connecting zone.

In an advantageous version, the circulation device is realized in such a way that the material-bonded connection is formed in the area of a force-fitting connecting system so that the material-bonded connection is consequently used for maintaining or fixing the previously formed force-fitting connection.

Preferably, the connecting system can be realized as a screw-connection device, and the material-bonded connection is formed between a nut or a bolt head of a threaded bolt of the screw-connection device and an adjacent CFC component or at least partially siliconized CFC component.

In another advantageous embodiment of the circulation device, the material-bonded connection is formed in the area of a form-fitting connecting system so that the material-bonded connection is consequently used for maintaining or fixing a form fit produced prior to the production of the material-bonded connection between the components to be interconnected.

According to another solution, the method according to the invention has the features of claim 18.

According to the invention, a connection between two CFC components or at least partially siliconized CFC components to be interconnected is formed by initially producing a force-fitting or form-fitting connection between the components in order to produce the circulation device. Only then, a material-bonded connection with a bonding material preferably containing silicon is formed in the area of a connecting zone formed in an area between the components.

Irrespective of how the production of the material-bonded connection is prepared, i.e. by producing an initially force-fitting connection or an initially form-fitting connection, a connecting material containing silicon is externally applied to the connecting zone of the components to be interconnected, said connecting zone preferably being locally limited, and subsequently the connecting material is melted so as to produce the material-bonded connection.

It has proved particularly advantageous if the connecting material is applied as a paste of polyvinyl alcohol or silicon powder with a content of 30 to 60 percent by weight of silicon.

If the silicon is melted in a vacuum or in a protective gas atmosphere, an embrittlement or an increase in porosity in the area of the connecting zone can be advantageously prevented to the furthest extent.

If in addition to silicon a carbon black content is added to the connecting material, it is possible to maximize the relative content of silicon that reacts with the carbon to form silicon carbide so that the content of free silicon in the connecting zone, which is preferably locally limited, is correspondingly minimized. This proves advantageous if the circulation device is used at high temperatures, which starting at about 1400° C. prevents the free silicon in the connecting zone from melting and thus the silicon from precipitating while the connecting zone is simultaneously weakened.

In the following, preferred embodiment examples of the invention are explained in more detail with the aid of the drawing.

In the figures:

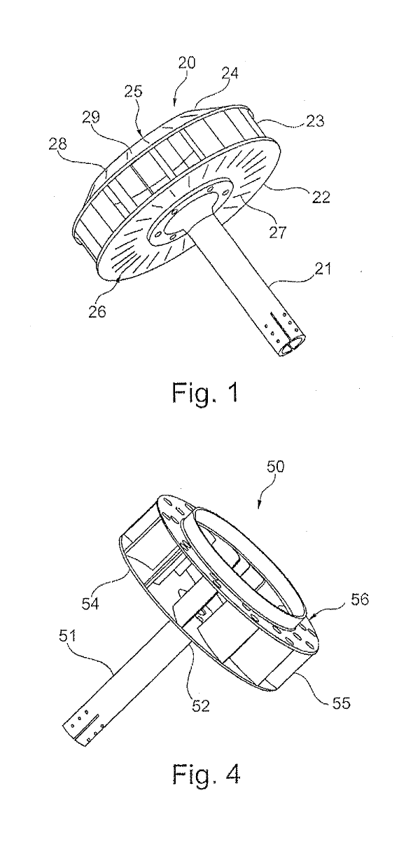

FIG. 1: shows a first embodiment of a circulation device in an isometric illustration;

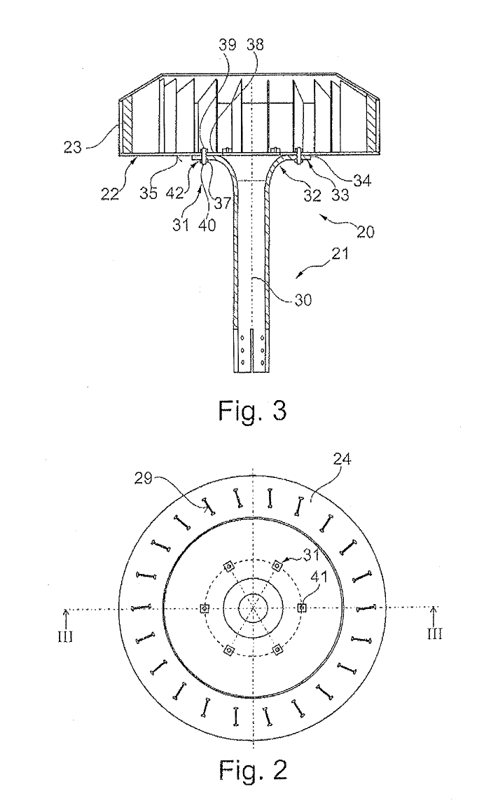

FIG. 2: shows the circulation device illustrated in FIG. 1 in a top view;

FIG. 3: shows the circulation device illustrated in FIG. 2 in a sectional view according to section line in FIG. 2;

FIG. 4: shows another embodiment of a circulation device in an isometric illustration;

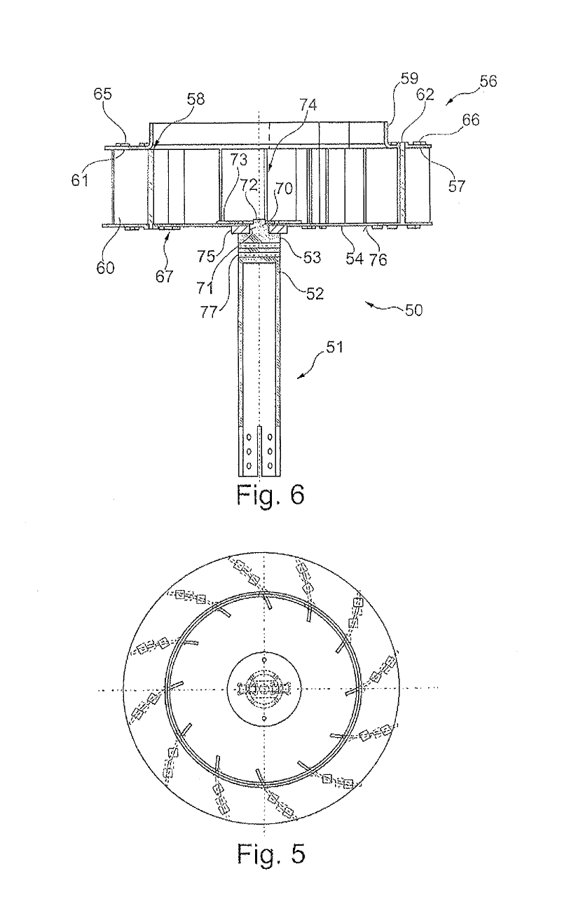

FIG. 5: shows the circulation device illustrated in FIG. 4 in a top view;

FIG. 6: shows the circulation device illustrated in FIG. 5 in a sectional view according to section line VI-VI in FIG. 5;

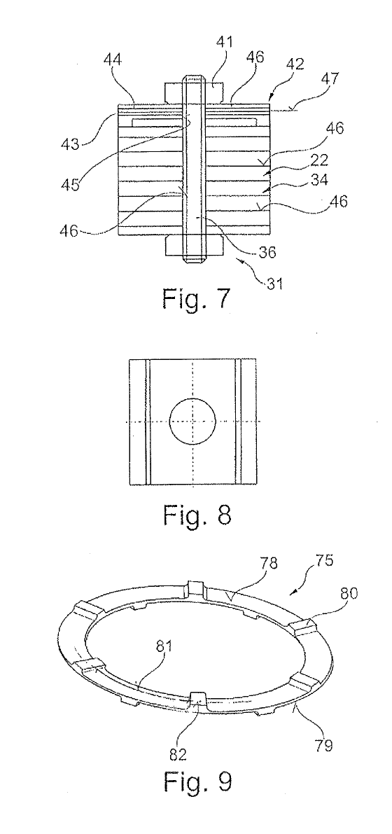

FIG. 7: shows an enlarged detail illustration of a screw-connection device on the circulation device illustrated in FIG. 1;

FIG. 8: shows a lateral view of a spring element used in the screw-connection device illustrated in FIG. 7;

FIG. 9: shows another embodiment of a spring element for a screw-connection device in an isometric illustration;

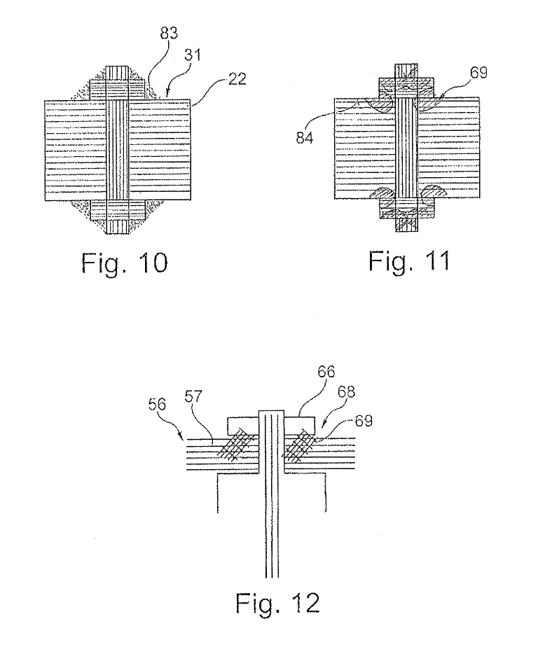

FIG. 10: shows an embodiment of a screw-connection device having a connecting material applied to the connecting zone between the components of the screw-connection device, said embodiment being an alternative to the screw-connection device illustrated in FIG. 7;

FIG. 11: shows the screw-connection device illustrated in FIG. 10 following a local welding of the components coated with the connecting material;

FIG. 12: shows an enlarged detail illustration of a screw-connection device on the circulation device illustrated in FIG. 6.

FIG. 1 shows a first embodiment of a circulation device 20 comprising a shaft 21 for connecting the circulation device 20 to a driving device (not illustrated) and a blade carrier 22 that is rigidly connected to the shaft 21 for co-rotation and is used for arranging thereon a plurality of blades 23 that are arranged in a distributed manner across the circumference of the blade carrier 22. As shown in FIG. 1, the blades 23 are accommodated between the blade carrier 22 and a conical end ring 24, for which purpose they are each inserted with their axial ends 27, 28 into slot-shaped recesses 29 of the blade carrier 22 and of the end ring 24 via form-fit connections 25 and 26, respectively.

As can be taken in particular from FIGS. 2 and 3, a plurality of screw-connection devices 31 is provided for connecting the shaft 21 to the blade carrier 22, said screw-connection devices being arranged concentrically to a center axis 30 of the circulation device 20. For connection to the blade carrier 22, the shaft 21 has a plate flange 33 that is formed on an axial connecting end 32 of the shaft 21 and that has a radially extending flange ring 34 that is in contact with a bottom side 35 of the disk-shaped blade carrier 22. The screw-connection devices 31 are realized in such a manner that a threaded bolt 36 penetrates passage holes 37, 38 in the flange ring 34 and in the blade carrier 22 and is provided with a nut 41 on each of its opposing axial ends 39, 40. In the embodiment example of the screw-connection device 31 illustrated in FIG. 2, a beam spring element 42 is arranged between the flange ring 34 and the nut 41 arranged at the lower axial end 40 of the threaded bold 36.

As can be taken from the detail illustration in FIG. 7, the beam spring element 42 has an elastic beam 44 that is supported with axial ends on support legs 43 and which is provided with a passage hole 45 for passage of the threaded bolt 36. The beam spring element 42 is realized as a CFC component having a fiber orientation 46 that within the area of the elastic beam 44 extends in the direction of a stress axis 47 running between the support legs 43 so that, in case of a stress on the elastic beam 44 due to a pre-tension force acting in the screw-connection device 31, the resulting tensile stress in the elastic beam 44 can be absorbed by the fibers of the CFC component.

As further becomes clear from the schematic illustration of FIG. 7, which also indicates the fiber orientation 46 in the flange ring 34 of the shaft 21 and in the blade carrier 22 as well as in the threaded bolt 36, all components of the crew-connection device 31 illustrated exemplarily in FIG. 7 are realized as CFC components, except for the nuts 41, which are exclusively loaded by pressure. In principle, it is of course also possible to realize the nuts 41 as CFC components and the threaded bolt 36 as a graphite component or to realize both components identically.

Owing to the elastic flexibility of the beam spring element, the screw-connection device 31, more precisely the threaded bolt 36 of the screw-connection device, can be loaded with a sufficiently high pre-tension force so that even if settling phenomena occur in particular vertically to the fiber orientation 46 in the porous carbon material of the components that are clamped together with a pre-tension force, the components can compensate them by means of the elasticity of the beam spring element 42, and the components clamped together via the screw-connection device 31 can still fit against each other with sufficient force to effectively prevent relative motions of the components.

In the circulation device 50 illustrated in FIG. 4, a shaft 51 is connected to a blade carrier 54 by means of a connecting piece 53 that is arranged at an axial connecting end 52 of the shaft 51.

In the circulation device 50, blades 55 are accommodated between the blade carrier 54 and an end ring 56, which, as illustrated in FIG. 6, is realized as a plane annular disk 57 having an annular projection 59 integrally formed on an inner circumference 58 of the annular disk 57. For connecting the blades 55 to the blade carrier 54 and to the end ring 56, threaded bolts 62 are integrally formed on both the lower axial end 60 and the upper axial end 61 of the blades 55, said threaded bolts 62 penetrating passage holes 63 in the blade carrier 54 and passage holes 64 in the annular disk 57 of the end ring 56 and each being provided with a nut 66 at their free axial ends 65, which is preferably made of graphite. The embodiment example of the circulation device 50 illustrated in FIG. 6 is different from the embodiment example of the circulation device 20 illustrated in FIGS. 1 to 3 in that the former is provided with screw-connection devices 67 that do not have a beam spring element 42. Instead of a beam spring element 42, the screw-connection devices 67 have an additional material-bonded connection 68, which, as illustrated in FIG. 12, is formed in a locally limited connecting zone 69 between the nut 66 and the annular disk 57 of the end ring 56.

As is shown in particular in FIG. 6, for connecting the shaft 51, the connecting piece 53 arranged at the axial connecting end 52 of the shaft 51 is guided through a central passage hole 71 with a threaded bolt 70 formed at the connecting piece 53 and is provided with a disk nut 73 at its free axial end 72, said nut, together with the threaded bolt 70, enabling a screw-connection device 74 for connecting the shaft 51 to the blade carrier 54.

Moreover, the screw-connection device 74 is provided with an annular spring element 75, which is illustrated as an individual component in FIG. 9 and is arranged between a bottom side 76 of the blade carrier 54 and the connecting piece 53 according to the illustration in FIG. 6. The connecting piece 53, which is realized as a graphite component in the present embodiment example, is rigidly connected for co-rotation to the tubular shaft 51 via pin connections 77.

As FIG. 9 shows, the annular spring element 75 has two opposing axial surfaces 78, 79 on a spring ring 85, which are each provided with support legs 80 that are arranged in a circumferentially distributed manner. The support legs 80 are arranged in such a way that each support leg arranged on an upper axial surface 78 is located between two support legs 80 arranged on the lower axial surface 79. The annular spring element 75 is realized as a CFC component having a fiber orientation 81 that, as indicated in FIG. 9, extends in the direction of a stress axis 82 running between the support legs 80 of the annular spring element 75. As explained before with reference to FIGS. 1 to 3 using the embodiment example of the beam spring element 42, the elastic flexibility of the annular spring element 75 allows compensation of settling phenomena in the screw-connection device 74.

With reference to the figure sequence of FIGS. 10 and 11, an option for producing the material-bonded connection 68 is explained in the following paragraphs, which is used in addition to a form-fitting connection 25, 26, as illustrated in FIG. 3, or alternatively also in addition to a screw-connection device.

As FIG. 10 shows using the example of the screw-connection device 31, first the screw-connection device 31 is coated in the area of the intended connecting zone 69 (FIG. 11) by applying a connecting material 83, which, in the present case, is applied as a pasty material and substantially consists of polyvinyl alcohol with a weight proportion of 50% silicon powder. Then, the connecting system is heated to a temperature above 1400° C. in a protective gas atmosphere, causing the silicon powder to melt and react with the carbon of the CFC component to form silicon carbide, the CFC component being formed by the blade carrier 22 in the case of the present embodiment example.

As indicated by the schematic illustration in FIG. 11, the reaction results in the formation of the connecting zone 69, which has a silicon carbide content that decreases with growing distance from a boundary layer 84 formed between the components.

Instead of silicon, which is acting as a carbide-forming agent in the afore-explained embodiment example, it is also generally possible to use other carbide-forming agents, such as metals, in particular titanium, tantalum or chromium, to produce metal carbides in the connecting zone or also other semiconductors than silicon, such as boron. In particular if carbon black is added to the silicon, the silicon is particularly suited as a carbide forming agent because the occurrence of free silicon in the connecting zone can be limited to the furthest extent by the use of carbon black so as to obtain a connecting zone that permits thermally stable material performance over a wide temperature range.

Although, in reference to the drawing figures, CFC, i.e. carbon fiber-reinforced carbon, is used as material for the components or building parts of the circulation device and the connecting system, it is expressly stressed that these components or building parts can also be made of siliconized carbon fiber-reinforced carbon (CMC) or of a CFC material that is siliconized at least in the area of its surface.

In addition to continuous fibers, short-cut fibers can also be used at least for the components of the connecting system, wherein, in case of the use of short-cut fibers, first a mixture of fibers and resin is produced, followed by molding and a carbonization and finally siliconization.

In the case of continuous fibers, first a carbon fiber-reinforced plastic (CFRP) is produced from a tissue or wound fibers with the addition of a resin, and the CFRP is then carbonized to be converted into a carbon fiber-reinforced carbon (CFC) and finally siliconized.

1. A circulation device for circulating an ambient atmosphere, the circulation device comprising:
a shaft for connecting the circulation device to a driving device;
a blade carrier connected to the shaft;
a plurality of blades arranged on the blade carrier for applying a flow impulse to the atmosphere, wherein the connection between the shaft and the blade carrier and the connection between the blade carrier and the blades are rigid connections for co-rotation so as to transmit a driving torque from the shaft to the blades, and both the blade carrier and the blades are carbon fiber-reinforced carbon (CFC) components or as at least partially siliconized CFC components; and
a connecting system interconnecting two of the CFC components or at least partially siliconized CFC components in a force-fitting manner, said connecting system exclusively having connecting elements consisting of CFC, at least partially siliconized CFC or graphite, and the connecting system having a spring element consisting of a CFC material, or an at least partially siliconized CFC material.

2. The circulation device according to claim 1, in which the connecting system is a screw connection device that has a threaded bolt consisting of a CFC material, an at least partially siliconized CFC material, or a graphite material, and at least a nut consisting of a CFC material, an at least partially siliconized CFC material, or a graphite material, and the spring element is arranged between the nut and a CFC component or an at least partially siliconized CFC component in such a manner that a pressure force is active between the nut and the CFC component or the at least partially siliconized CFC component.

3. The circulation device according to claim 2, in which the threaded bolt is provided with a bolt head and the threaded bolt penetrates two CFC components or at least partially siliconized CFC components to be interconnected in a force-fitting manner that are arranged between the bolt head of the threaded bolt and the nut.

4. The circulation device according to claim 3, in which the bolt head is formed by a nut consisting of a CFC material, an at least partially siliconized CFC material, or a graphite material.

5. The circulation device according to claim 2, which the threaded bolt is formed on a first one of the CFC components or at least partially siliconized CFC components to be interconnected in a force-fitting manner and penetrates another CFC component or at least partially siliconized CFC component, which is arranged between the first one of the CFC components and the nut.

6. The circulation device according to claim 1, in which the spring element is a beam spring element having two support legs for support on a CFC component or at least partially siliconized CFC component and an elastic beam connecting the support legs for support on the bolt head or the nut of the screw-connection device.

7. The circulation device according to claim 1, in which the spring element is an annular spring element having a spring ring that has support legs on two opposing axial surfaces, said support legs being arranged in a radially distributed manner on the axial surfaces in such a way that each support leg formed on one axial surface of the two opposing axial surfaces is arranged between two support legs formed on the other axial surface of the two opposing axial surfaces.

8. The circulation device according to claim 1, in which the shaft has a plate flange that is formed on an axial connecting end of the shaft and has a radially extending flange ring on which the blade carrier formed as a disk is arranged, and that the connecting system is formed as a screw-connection device between the shaft and the blade carrier.

9. The circulation device according to claim 8, in which the blade carrier, the blades, and the shaft are all CFC components or at least partially siliconized CFC components.

10. The circulation device according to claim 9, in which for connecting the shaft to the blade carrier, the flange ring of the shaft is connected to the blade carrier by a plurality of threaded bolts arranged in a radially distributed manner and are each provided with a beam spring element.

11. The circulation device according to claim 1, in which at an axial connecting end, the shaft is provided with a connecting piece having a threaded bolt and the connecting system is a screw-connection device between the shaft and the blade carrier.

12. The circulation device according to claim 11, in which for connecting the shaft and the blade carrier, the threaded bolt of the connecting piece penetrates the blade carrier so as to form the screw-connection device, and an annular spring element is arranged between the connecting piece and the blade carrier.

13. The circulation device according to claim 6, in which at least the elastic beam of the beam spring element has a fiber alignment with fibers that extend along a stress axis that connects the support legs.

14. A circulation device for circulating an ambient atmosphere, the circulation device comprising:
a shaft for connecting the circulation device to a driving device;
a blade carrier connected to the shaft; and
a plurality of blades arranged on the blade carrier for applying a flow impulse to the atmosphere, wherein the connection between the shaft and the blade carrier and the connection between the blade carrier and the blades are rigid connections for co-rotation so as to transmit a driving torque from the shaft to the blades, and both the blade carrier and the blades are carbon fiber-reinforced carbon (CFC) components or as at least partially siliconized CFC components, at least one of the two connections being realized in such a manner that two CFC components or at least partially siliconized CFC components to be interconnected are interconnected by a force-fitting or form-fitting connection that is secured by a material-bonded connection in a connecting zone formed between the components.

15. The circulation device according to claim 1, in which the material-bonded connection has a connecting material that contains silicon.

16. The circulation device according to claim 1, in which the connecting zone has a carbide content that decreases with growing distance from a boundary layer formed between the components.

17. The circulation device according to claim 16, in which the connection is a screw-connection device and the material-bonded connection is formed between a nut or a bolt head of a threaded bolt of the screw-connection device and an adjacent CFC component or at least partially siliconized CFC component.

18. A method for producing a circulation device according to claim 14, in which for producing a connection between two CFC components or at least partially siliconized CFC components to be interconnected, a force-fitting or form-fitting connection is first produced between the two CFC components and a material-bonded connection is subsequently produced in an area of a connecting zone between components of the force-fitting or form-fitting connection by a connecting material.

19. The method according to claim 18, in which for producing the material-bonded connection, the connecting material is externally applied to the connecting zone of the components and then the connecting material is melted.

20. The method according to claim 19, in which the connecting material is applied as a paste including polyvinyl alcohol and silicon powder with a content of 30 to 60 w-% of silicon.

21. The method according to claim 18, in which the connecting material is melted in a vacuum or in a protective gas atmosphere.

22. The method according to claim 20, in which a carbon black content is added to the connecting material in addition to the silicon.

23. The method according to claim 18, in which a metal content is added to the connecting material.

24. The method according to claim 23, in which a metal content of 20 to 70 w-% is added to the connecting material.

25. The circulation device according to claim 7, in which at least the spring ring of the annular spring element has a fiber alignment with fibers that extend along a stress axis that connects the support legs.
